(19) United States
(12) Patent Application Publication
(10) Pub. No.: US 2004/0021936 A1
(43) Pub. Date: Feb. 5, 2004

(54) Microscope with and automatic focusing device

(76) Inventors: Norbert Czarnetzki, Jena (DE); Thomas Scheruebl, Jena (DE); Stefan Mack, Freiburg (DE); Toshiro Kurosawa, Saitama-shi Saitama Pref (JP)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/415,048

(22) PCT Filed: Mar. 15, 2002
(86) PCT No.: PCT/EP02/02878

(30) Foreign Application Priority Data
Mar. 16, 2001 (DE) 101 12 639.5

(51) Int. Cl. G02B 21/00

(52) U.S. Cl. 359/368

(57) ABSTRACT

A microscope comprises an illumination source, an optical imaging device by which light from the illumination source in the form of an illuminated field is directed onto an observed object, a reception device which receives the light influenced by the observed object in the from of an image field corresponding to the illuminated field, and a device for adjusting the distance between the imaging device and the observed object. Further, there is a device for structuring the illumination light in the beam path between the illumination source and the imaging device with two or more diaphragms spaced apart axially in the direction of the beam path. The diaphragms are arranged in such a way that a plane lying therebetween is focused in the image field on the reception device at the same time as the observed object. An evaluating device generates an actuating signal (s) for actuating the adjusting device depending on the intensities.

### CROSS-REFERENCE TO RELATED APPLICATIONS

This application claims priority of PCT Application Serial No. PCT-EP02/02878 filed Mar. 15, 2002 and German Application No. 101 12 639.5 filed Mar. 16, 2001, the complete disclosures of which are hereby incorporated by reference.

### BACKGROUND OF THE INVENTION

a) Field of the Invention

The invention is directed to a microscope with autofocusing device comprising an illumination source, an optical imaging device by means of which illumination light in the form of an illuminated field is directed onto an observed object, a reception device which receives light influenced by the observed object in the form of an image field corresponding to the illuminated field, and a device for changing the distance between the imaging device and the observed object.

b) Description of the Related Art

Microscopes of the type mentioned above are used, for example, for confocal microscopy in which the observed object to be examined and the microscope are moved relative to one another and the observed object is optically scanned in this way.

The light falling on the observed object from the illumination source is reflected more or less strongly by the observed object and is imaged aged on the reception device by means of the imaging device, so that information about the observed object or the object area being examined at that moment can be obtained based on the imaging.

In particular, a section plane in which the object or a selected area of the object is to be sharply imaged is selected from the topography of the object surface. When deviations occur during the positioning of the observed object relative to the imaging device in the direction of the optical axis, the distance between the observed object and the imaging device is corrected by means of an adjusting device until the focus position is achieved.

Particularly when monitoring continuously running manufacturing processes such as during the inspection of wafers, it is desirable that focusing of the optical imaging device on the wafer surface or on a layer of the wafer to be examined is carried out automatically.

In this connection, there are already many autofocusing devices for optical systems known from the prior art which differ with respect to operation and performance parameters. The latter include particularly the resolution in the direction of the optical axis (hereinafter referred to as z-axis), the depth of the capture area or work area, the possibility of generating a direction signal for a corrective adjusting movement, and the attainable measurement speed.

Although they allow a relatively large capture area, autofocusing devices working with triangulation methods are limited to orders of magnitude of about 300 nm with respect to the resolution in direction of the z-axis and are accordingly not suited for wafer inspection which requires resolutions in the order of magnitude of about 50 nm with a capture range of several μm.

Autofocusing devices used in CD players, for example, have a relatively large capture range and also a high z-resolution, but can only be used when the surface in question has very good reflection characteristics.

As a rule, a laser beam is used for autofocusing in these devices. However, when the wavelength spectrum of the main optical system diverges sharply from that of the autofocusing system, systematic errors result during focusing, these systematic errors depending, among other things, upon material properties and the microstructure, e.g., of a surface coating, of the observed object to be examined. When the main optical system is operated in a wavelength range different than that of the autofocusing system, separate system components must be provided for the latter. This in turn involves separate beam guidance at least in some areas. Also, the main system must be specially designed for the separate wavelength of the autofocusing system.

### OBJECT AND SUMMARY OF THE INVENTION

Against this background, it is the primary object of the invention to provide a microscope of the type mentioned in the beginning which enables highly accurate focusing on an observed object to be examined in a simply designed construction.

This object is met for a microscope according to the preamble of claim 1 in that a device for structuring the illumination light is arranged in the beam path between the illumination source and the imaging device or in a position optically conjugate thereto, the device for structuring the illumination light has two or more diaphragms at a distance from one another axially in the direction of the beam path. A first diaphragm and a second diaphragm are arranged in such a way that a plane located between these diaphragms is focused in the image field on the reception device at the same time as the image of the observed object or portion of the observed object which is in a reference position.

Further, a device cooperating with the reception device is provided for evaluating the light intensities of the partial area of the image field influenced by the diaphragms and, depending on the evaluated intensities, the evaluating device generates an actuating signal for actuating the adjusting device for focusing the plane located between the diaphragms.

Except for the additional device for structuring light, the autofocusing device according to the invention makes use of all components of the main optical system, particularly its illumination source, its optical imaging device and its reception device, which allows for a simply designed construction. Since the same illumination source is used for the main optical system as well as for the autofocusing system, the systematic errors mentioned above are avoided. The diaphragms which are arranged at a distance from one another in the direction of the beam path act only on a small portion of the image field, while most of the image field remains usable for the microscope imaging.

The light intensities measured in the partial areas of the image field that are associated with the diaphragms depend upon the actual distance between the observed object and the optical imaging device in the direction of the z-axis. Since the diaphragms are positioned differently with respect to one another in the direction of the beam path, an intensity characteristic associated with the respective diaphragm is given for every diaphragm depending on the z-position of the observed object.

By evaluating the light intensities with respect to the individual diaphragms, the actual position of the observed object can be determined and therefore any deviation from a reference position can be determined. Further, the direction along the z-axis in which the actual position of the observed object deviates from the reference position and in which the focus must accordingly be adjusted can be determined in this way. With this information, the position of the observed object in relation to the reference position can then be corrected, i.e., precisely focused.

Resolutions along the z-axis in the order of magnitude of 50 nm with a capture range of several μm can be realized by the autofocusing device according to the invention with high measuring speed.

The actuating signal can be generated, for example, directly on the basis of the light intensities which are determined for the individual diaphragms and whose magnitudes are related to one another for this purpose. Of course, quantities derived from the light intensity can also be used for generating the actuating signal.

In an advantageous embodiment of the invention, the evaluating device for generating the actuating signal is constructed, for example, in such a way that a comparison value is generated from the detected light intensities or from contrast values derived from these light intensities and the adjustment direction for the adjusting device can then be derived from this comparison value. In this way, the actuating signal or regulating input signal for the adjusting device can be obtained in a particularly simple manner. The comparison value may also be related to a reference value.

In order to improve accuracy, it is occasionally advantageous to generate the comparison value by subtracting intensity values and/or contrast values and/or by dividing intensity values and/or contrast values, so that a scaling of the actuating signal or regulating input signal for the adjusting device can be carried out.

The diaphragms are preferably constructed and arranged in such a way that a high-contrast light structure is generated on the reception device when the observed object is located in a determined z-position for the respective diaphragm. As a result, noticeably different contrast values are generated when the observed object deviates from the reference position for the individual diaphragms. The deviation of the observed object from the reference position can be determined in a particularly precise manner in this way.

In principle, it is possible to allocate to each diaphragm its own partial area of the image field, wherein the partial areas of the individual diaphragms do not mutually influence one another. In this case, the intensities are allocated to the individual diaphragms on the reception device in a uniquely defined manner, so that the measured intensities can be evaluated in a particularly simple manner, e.g., also with determination of contrast. In this connection, a confocal arrangement of the diaphragms proves particularly advantageous. In this case, the detector area corresponds to the image of the diaphragm structure and a fast evaluation is possible because no computing time is required for determining contrast.

In order that the image field of the main optical system is limited as little as possible by the partial areas needed for the autofocusing system, it is particularly advantageous when the diaphragms viewed in the direction of the optical axis overlap one another at least partly, and each diaphragm is constructed so as to be partially transparent to light and the diaphragms have optical structuring patterns which diverge from one another. The diaphragms which are consequently located one behind the other in the beam path generate combined intensities on the reception device. Because of the different structuring patterns, however, characteristic values which depend upon the focus position of the observed object can be attributed to the individual diaphragms by analyzing the measured intensities. The actuating signal for a possible position correction is then generated from this information that is to be attributed to the individual diaphragms.

For example, the diaphragms can be provided with grating structures which diverge from one another, wherein the grating lines of different diaphragms extend transverse to one another and/or are spaced differently. When more than two diaphragms are used, the grating structures differ from one another in pairs by at least one geometric criterion.

In another advantageous development of the invention, a third diaphragm is arranged between the first diaphragm and the second diaphragm in such a way that the imaging of the third diaphragm is focused in the image field on the reception device at the same time as the imaging of the observed object or portion of the observed object in a reference position.

When the observed object is in the reference position, there is a maximum of the contrast value during a contrast evaluation for the third diaphragm in this position. During a brightness evaluation, a maximum of the intensity or brightness is also determined in this position. Accordingly, additional information is obtained by which the “correct” positioning of the observed object in the reference position can be verified. This is particularly advantageous when the additional diaphragms only have only low contrast values or brightness values in the reference position. This also offers the advantage of a greater capture range and there is also a possibility of scaling.

In order to achieve a large capture range, a plurality of diaphragms can be provided in the direction of the beam path. The only limitations in this case are given by the required surface of the image field for the autofocusing system or the transmission characteristics of the diaphragms that are used insofar as they are arranged so as to overlap one another in the direction of the beam path. A large capture area can be realized by means of a greater quantity of diaphragms in extrafocal and intrafocal arrangement. For practical purpose, however, it has proven favorable and sufficient to provide three diaphragms, where the construction remains relatively simple.

In another advantageous constriction of the invention, the first diaphragm and the second diaphragm have a large number of individual pinhole diaphragms which are arranged in such a way that their images on the reception device are separate from one another. In this connection, a separate, light-sensitive area of the reception device is allocated to every image. Accordingly, an arrangement of a plurality of groups is realized in each instance in confocal beam paths which are offset relative to one another in axial direction.

An arrangement of this kind is suitable particularly for direct evaluation of intensities or confocal brightness. For example, it is possible to relate the intensity values of closely neighboring individual openings of different diaphragms to one another directly and then to generate an actuating signal from this. Further, individual characteristic intensity values and brightness values can also be determined initially for all diaphragms and compared to one another subsequently in order to generate the actuating signal.

The pinhole pattern that is imaged in the image field can also be made use of for determining contrast values for the diaphragms, in which case a confocal relationship between the individual pinhole diaphragms and the light-sensitive areas on the reception device, for example, the pixels of a CCD matrix, is not strictly necessary.

As an alternative to the individual pinhole diaphragms, the first diaphragm and the second diaphragm can each be formed by a plurality of stripe-shaped individual diaphragm apertures whose imaginary longitudinal extension directions intersect at a common point lying on the optical axis of the optical imaging device. Also, in this case, the individual diaphragm apertures are arranged in such a way that their projections or images on the reception device are separate from one another, each image having its own light-sensitive area on the reception device associated with it.

In this way, fluctuations of the imaging characteristics of the optical imaging device in the percentile range, e.g., caused by the change of objective, can be compensated without affecting the focusing accuracy.

Depending on the length of the stripe-shaped individual diaphragm apertures, observation objectives with different imaging characteristics can also be used, wherein the length of the individual diaphragm apertures is such that the light-sensitive areas at the reception devices are always covered in the desired magnification area.

In another advantageous construction of the invention, devices are provided for moving the observed object in a direction transverse to the optical axis of the imaging device and the structuring patterns formed at the diaphragms are repeated in the movement direction of the observed object.

In this way it is possible to evaluate information about the same points on the observed object for generating the actuating signal even with diaphragms lying next to one another in the cross section of the beam path. For this purpose, in a first position of the observed object, the light falling through a diaphragm and its intensity for the above-mentioned point are measured initially and the intensities obtained in this way are recorded. The observed object is subsequently displaced in a plane vertical to the z-axis in such a way that the light reflected by said points now lies in the range of influence of another diaphragm. The corresponding intensities are recorded in relation to said points and are related to one another for the individual points.

A measurement of this kind is preferably carried out for every diaphragm present. With a larger quantity of diaphragms, however, the measurement can also be limited to a selected quantity of specifically selected diaphragms.

Further, it lies within the framework of the invention to construct the reception device as a TDI (time delayed integration) camera for the continuous measurement of light intensities which sums the intensity values of n successive measurements at a point on an observed object. The structuring patterns at each of the diaphragms are repeated n-times in the movement direction of the observed object corresponding to the quantity of measurements.

The individual intensity values of the n successive measurements can be related to one another electronically within the TDI camera and processed to give measurement results. Above all, a high measuring speed can be achieved in this way.

In the following, the invention will be described in more detail with reference to embodiment examples shown in the accompanying drawings.

### BRIEF DESCRIPTION OF THE DRAWINGS

In the drawings:

FIG. 1 shows a schematic view of an embodiment example for a microscope with autofocusing according to the invention focused on an observed object;

FIG. 2 shows the microscope from FIG. 1 in an out-of-focus or defocused state;

FIGS. 3a, b show an example for the arrangement of a plurality of diaphragms in the beam path of the microscope, where 3a is a side view of the beam path and 3b is a view in the direction of the beam path;

FIG. 4 is a graph illustrating the contrast values caused by the diaphragms from FIG. 3 as a function of a distance of the observed object to be examined from an optical imaging device in the direction of the optical axis or in z-direction;

FIG. 5 shows another example for the arrangement of diaphragms in the beam path of the microscope according to FIG. 1 and FIG. 2, wherein 5a is a side view of the beam path and 5b is a view in the direction of the beam path;

FIGS. 6a, b show a third example for the arrangement of diaphragms in the beam path of a microscope according to FIG. 1 and FIG. 2, where 6a is a side view of the beam path and 6b is a view in the direction of the beam path;

FIGS. 7a, b show a fourth example for the arrangement of diaphragms in the beam path of a microscope according to FIGS. 1 and 2, where 7a is a side view of the beam path and 7b is a view in the direction of the beam path; and

FIGS. 8a, b show a schematic view illustrating autofocusing methods in which the observed object to be examined is recorded multiple times and displaced between the recordings for purposes of autofocusing.

### DESCRIPTION OF THE PREFERRED EMBODIMENTS

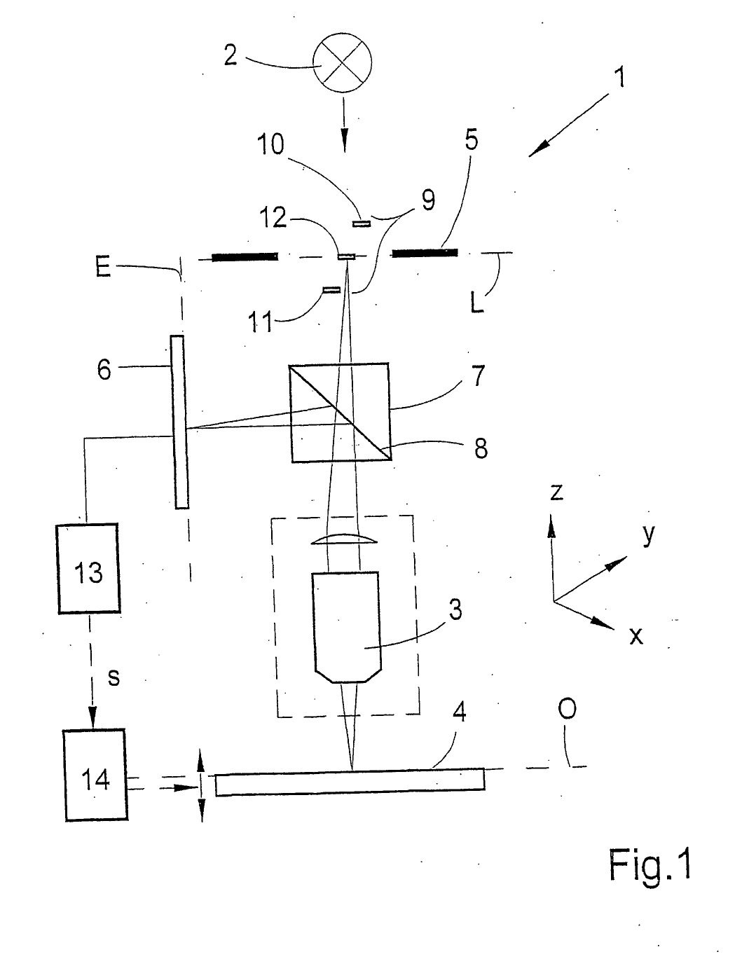

FIG. 1 shows, by way of example, a microscope 1 with autofocusing in which the main optical system and the autofocusing system make use of the same optical components. However, FIG. 1 shows only the beam path of the autofocusing system that is relevant in the present connection.

The microscope 1 comprises a central illumination source 2 which radiates light in the visible range, for example. Further, an optical imaging device 3 is provided which includes an observation objective. Light from the illumination source 2 in the form of an illuminated field is directed by the optical imaging device 3 to an observed object 4 to be examined. The shape of the illuminated field is given by a field diaphragm 5 arranged between the illumination source 2 and the observation objective of the optical imaging device 3.

The microscope 1 further comprises a reception device 6 which receives light influenced by the observed object in the form of an image field corresponding to the illuminated field. The reception device 6 is constructed in the present case as a CCD matrix by means of which the intensity of the impinging light is determined. FIG. 1 shows a state of the microscope 1 in which it is focused on the observed object 4 and in which the illuminated field plane L in which the field diaphragm 5 is arranged is sharply imaged on the plane E of the reception device 6. In this state, the observed object 4 is located with its surface in the reference position that is indicated in the present case by plane O.

The light reflected by the observed object 4 is captured by the optical imaging device 3 and directed on to the reception device 6 via a deflecting device 7 with a partially transparent layer 8.

FIG. 1 further shows a device 9 arranged in the area of the field diaphragm 5 for structuring the light of the illumination source 2. This device 9 comprises three diaphragms 10, 11 and 12. These diaphragms 10, 11 and 12 are arranged in the area of the illuminated field so that they influence a portion of the image field which impinges on the reception device 6.

As can be seen from FIG. 1, the individual diaphragms 10, 11 and 12 are offset relative to one another in the direction of the optical axis of the microscope 1. A first diaphragm 10 is in an extrafocal position in front of the illuminated field plane L. A second diaphragm 11, on the other hand, is displaced toward the intrafocal side relative to the illuminated field plane L. The two diaphragms 10 and 11 are an arranged in such a way that a plane located between them, in this case the illuminated field plane L, is sharply imaged on the reception device 6 when the observed object 4 is in the reference position, i.e., in this case, with its surface at the height of the plane O. In the first embodiment example, a third diaphragm 12 is provided in the illuminated field plane L which accordingly lies between the first diaphragm 10 and the second diaphragm 11, for example, in the center.

The individual diaphragms 10, 11 and 12 are constructed in such a way that they affect only a small portion of the image field. Most of the image field remains usable for the microscope imaging. A high-contrast light structure is generated by each of the diaphragms 10, 11 and 12 on the observed object 4 when the respective diaphragm is optically conjugate to the observed object 4.

When the observed object 4 is displaced in the direction of the optical axis, i.e., in z-direction, the contrast of the light structure on the observed object 4 and, therefore, on the reception device 6, changes. The corresponding light intensities are detected at the reception device 6 in correlation with the respective diaphragm and are processed in an evaluating device 13. In particular, an actuating signal s is generated in the evaluating device 13 depending on the evaluated intensities, which actuating signal s serves as a regulating input quantity for an adjusting device 14 by means of which the observed object 4 can be moved along the z-axis in order to focus the latter in relation to the imaging device or to correct deviations from the reference position during the scanning of the observed object 4.

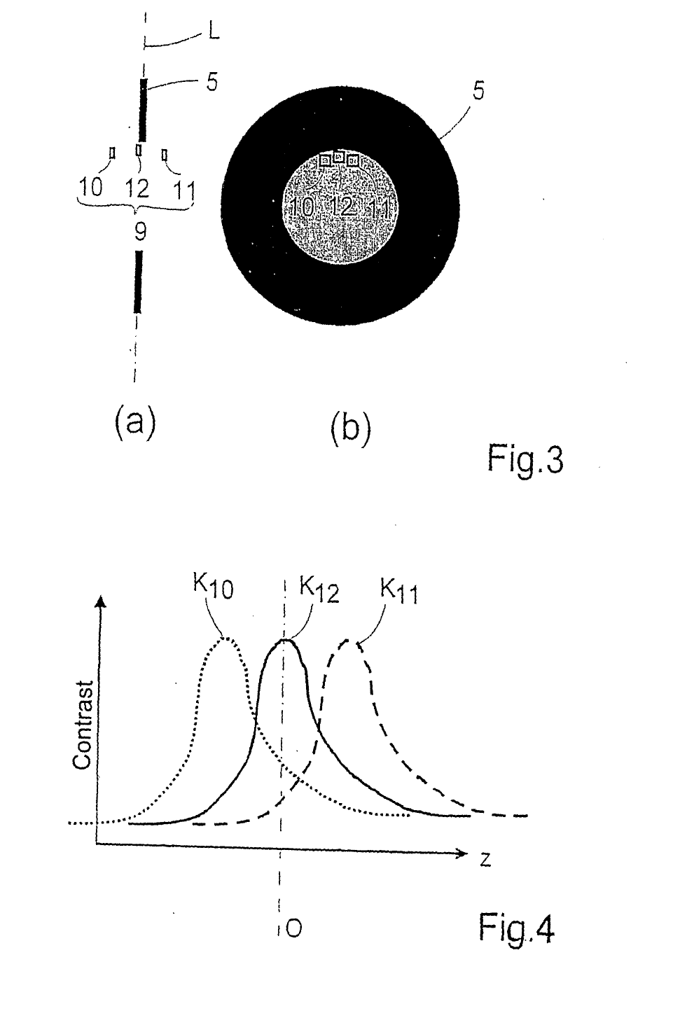

The dependence of the contrast on the reception device 5 with respect to the individual diaphragms 10, 11 and 12 upon the position of the observed object 4 in z-direction for the arrangement of diaphragms 10, 11 and 12 shown in detail in FIG. 3 can be seen in FIG. 4 from the contrast value curves K₁₀, K₁₁, and K₁₂ associated with the diaphragms. Since the diaphragms 10, 11 and 12 are arranged so as to be offset relative to one another in the direction of the optical axis, the contrast value curves K₁₀, K₁₁ and K₁₂ have maxima which are displaced relative to one another depending on the position of the observed object 4.

The diaphragms are constructed in such a way that the contrast of the respective associated light structure decreases noticeably, for example, by 50%, when the observed object 4 to be examined is in a z-position between positions of the observed object 4 in which neighboring diaphragms are focused on the reception device 6. A high sensitivity can be realized by steep contrast functions.

When the observed object 4 is in a reference position, the light structure of the third, center diaphragm 12 is imaged in a focused manner on the reception device 6. The associated contrast value curve K₁₂ accordingly has a maximum in the associated z-position. On the other hand, the light strictures of the first and second diaphragms 10 and 11 are imaged on the reception device in a defocused manner, so that the contrast value of the associated contrast value curves K₁₀ and K₁₂ is comparatively small. With a symmetric arrangement of the first diaphragm 10 and second diaphragm 11 in relation to the center diaphragm 12, the corresponding contrast values are approximately equal.

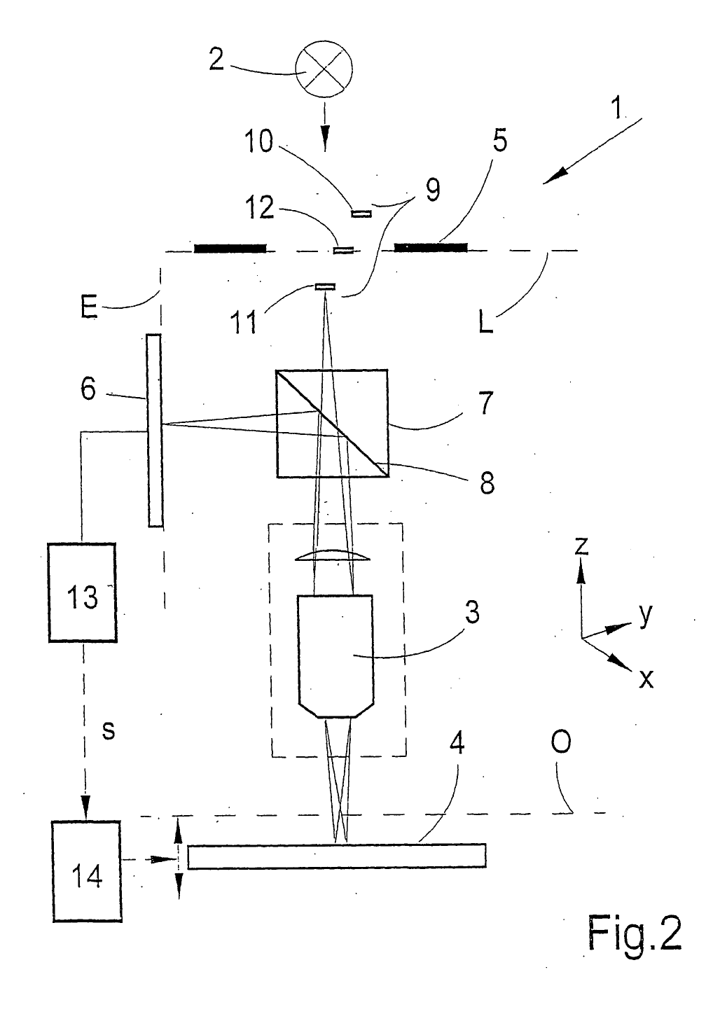

On the other hand, when the observed object 4 is located outside of the reference position in the z-direction, other contrast values result for the individual diaphragms 10, 11 and 12, on the basis of which the deviation can be determined. FIG. 2 shows the case of a deviation in which the second, intrafocal diaphragm 11 is sharply imaged on the reception device 6. The diaphragms 10 and 12 are then imaged in a defocused manner on the reception device 6, wherein the imaging of the first diaphragm 10 that is located at a greater distance is more defocused than the image of the center, third diaphragm 12. In this case, the contrast value K₁₁ of the second diaphragm 11 has a maximum toward which the contrast values of K₁₀ and K₁₂ of the other diaphragms 10 and 12 decrease.

This change in the contrast values is used for autofocusing. The aim of autofocusing is to maximize the contrast value K₁₂ of the center, third diaphragm 12 because the observed object 4 occupies its reference position in this state. With a deviation from the reference position, an actuating signal or regulating input signal s is generated by means of the contrast values K₁₀ and K₁₁ of the extrafocal and intrafocal diaphragms 10 and 11, which actuating signal or regulating input signal s, in addition to the quantity of the deviation, also contains information about the direction in which the correction is to be carried out along the z-axis.

In the simplest case, the contrast values K₁₀ and K₁₁ of the first diaphragm 10 and second diaphragm 11 are subtracted. The deviation of this difference from a given reference value then gives the desired direction information for the corrective movement of the adjusting device 14 for bringing the observed object 4 into the reference position.

In order to determine the contrast values, the measured intensities of a plurality of pixels are evaluated at the CCD matrix of the reception device 6 for each diaphragm 10, 11 and 12.

However, it is also possible to relate the measured intensities for the individual diaphragms directly to one another instead of the contrast values. This assumes a confocal-like constriction, i.e., the detector size must correspond to the size of the image of the diaphragm structure.

In both cases, the capture area can be enlarged in that the quantity of spaced extrafocal and intrafocal diaphragms is increased, e.g., doubled or tripled. But it is also conceivable to increase the capture area on one side and accordingly to from the focal diaphragm asymmetrically.

Further, it is possible to use mathematical functions for the regulating input signal.. These mathematical functions include the differences and/or quotients of the contrast values of the extrafocal and intrafocal diaphragms and, in addition or alternatively, take into account intensity values in order to achieve a scaling of the determined values, for example.

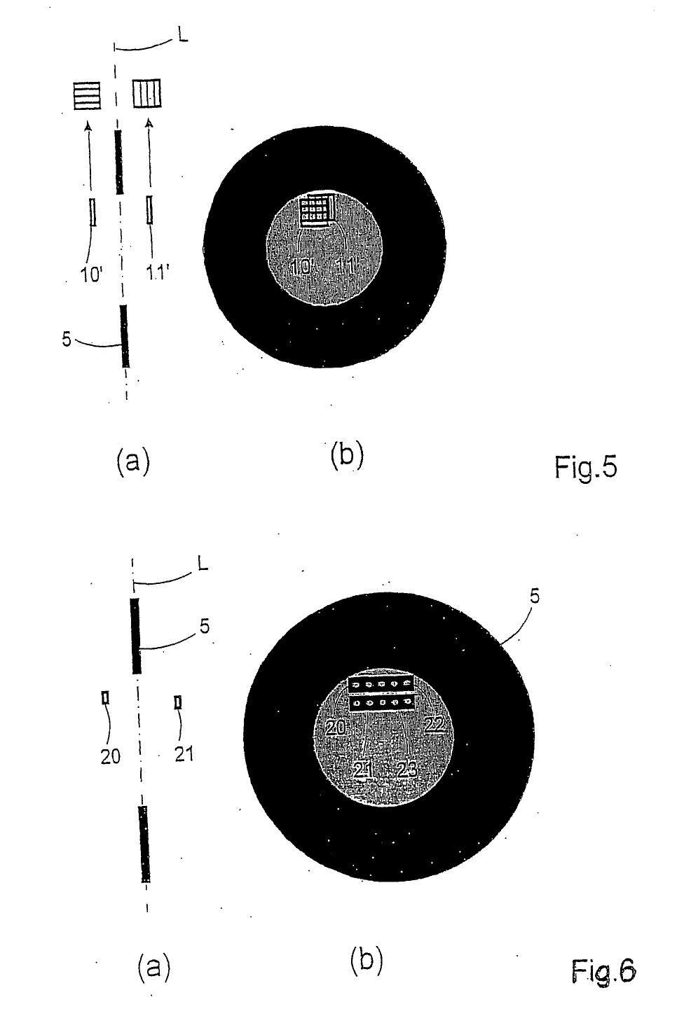

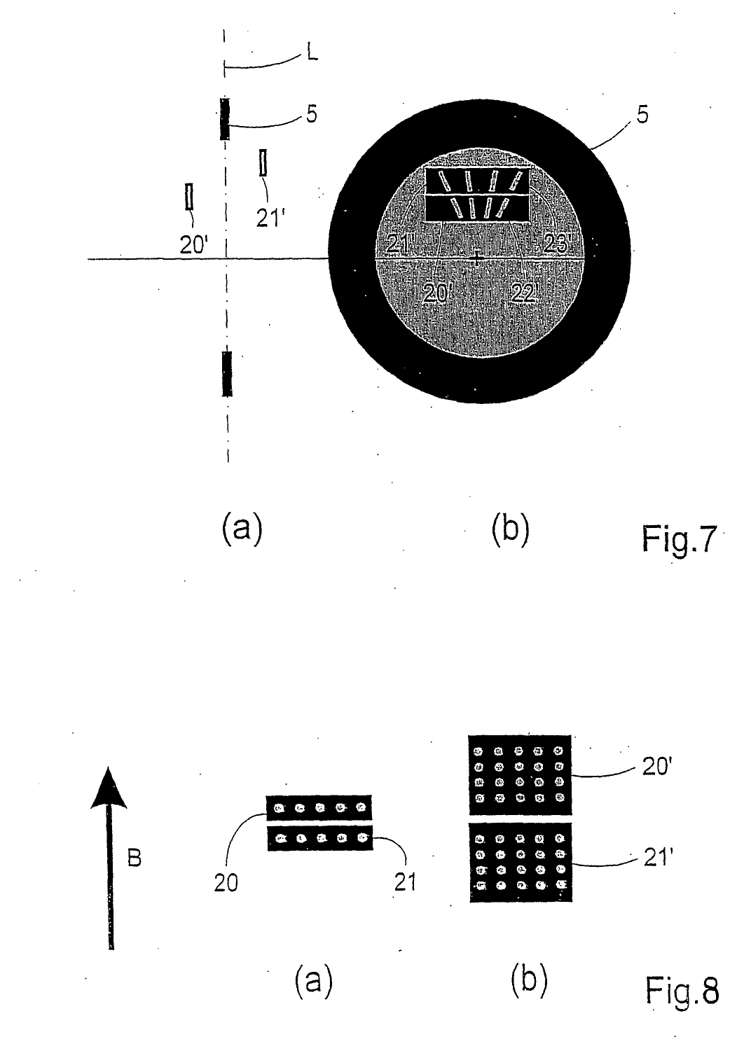

FIG. 5 shows another example for a diaphragm arrangement which can be used with the microscope 1 from FIG. 1. In contrast to the first embodiment example, the diaphragm arranged in the illuminated field plane L is omitted in this case. Further, the first diaphragm 10′ and the second diaphragm 11′ are arranged so as to overlap viewed in the direction of the optical axis, wherein every diaphragm 10′ and 11′ has a sufficiently high transmission so that the light of the illumination source 2 is not weakened too much by the diaphragm arrangement. Further, every diaphragm 10′ and ′ has an optical structuring pattern that is different from the other diaphragm, which makes itself noticeable when analyzing the light influenced by these diaphragms. Accordingly, each of the diaphragms 10′ and 11′ is assigned its own contrast value.

In the example shown in FIG. 5, each of the diaphragms 10′ and 11′ is provided with a grating structure. The diaphragms 10′ and 11′ are arranged relative to one another in such a way that the directions of their grating lines intersect. A separate contrast value with which a regulating input signal s for determining the direction of the position correction of the observed object 4 along the z-axis can be obtained analogous to the procedure described in connection with FIG. 4 can then be allotted to every diaphragm at the reception device 6 by determining the contrast in a first direction and in a second direction transverse to the first direction.

A third example for an autofocusing device based on a structured multiple-plane illumination is shown in FIG. 6. Instead of contrast patterns, a plurality of small individual pinhole diaphragms of any desired shape are located on the extrafocal and intrafocal diaphragms 20 and 21. The size dimensions of the individual pinhole diaphragms 22 and 23 correspond approximately to the Airy diameter in the observed object space multiplied by the magnification scale for the imaging between the field diaphragm 5 and the observed object 4.

The images of the individual pinhole diaphragms on the reception device 6 do not overlap. Rather, a separate, light-sensitive area is assigned to every individual pinhole diaphragm 22 and 23 on the reception device 6.

In the present embodiment example, the individual pinhole diaphragms 22 and 23 are arranged in line form, so that every pinhole diaphragm corresponds to one or more pixels on the reception device 6 which is preferably constructed as a CCD matrix. The pixels are read out selectively for the individual pinhole diaphragms 22 and 23. An arrangement of a plurality of confocal beam paths which extend so as to be offset relative to one another in axial direction is realized in this way. The reception device 6 accordingly detects the confocal intensity for every diaphragm 20 and 21 and every pinhole diaphragm 22 and 23, respectively. The regulating input signal for the autofocusing is generated by the values for the confocal intensity of the—in this case—two diaphragms 20 and 21 in a procedure analogous to that described above.

When the imaging device 3 works with a plurality of observation objectives with different imaging characteristics, different light-sensitive areas must be analyzed, as the case may be (depending on the imaging characteristics), when using the above-described diaphragms 20 and 21 with individual pinhole diaphragms for evaluation on the reception device 6.

This can be avoided through the use of diaphragms 20′ and 21′ at which stripe-shaped individual pinhole apertures 22′ and 23′ are formed instead of the circular individual pinhole diaphragms. The width of the stripes corresponds approximately to the diameter of the individual pinhole diaphragms 22 and 23 mentioned above. In order to compensate for differences in magnification, the stripe-shaped individual diaphragm apertures 22′ and 23′ are arranged in such a way that their imaginary longitudinal extension directions intersect at a common point on the optical axis of the optical imaging device 3. When the magnification changes, the imaging of the stripe-shaped individual diaphragm aperture on the reception device 6 is accordingly displaced along the imaginary longitudinal extension direction, so that the same light-sensitive area on the reception device 6 is always covered in the range of possible imaging scales of the observation objectives that are used for every stripe-shaped individual diaphragm aperture 22′ and 23′.

With the autofocusing devices described above in which diaphragms which do not overlap one another are used, light that has been reflected from different points on the observed object 4 is analyzed in a measurement at a static observed object 4 via the individual diaphragms, so that the regulating input signal s in these cases is generated to a certain extent from an averaging of the intensities over the totality of areas considered for autofocusing.

The focusing accuracy can also be further improved in that light from identical areas of the observed object 4 is analyzed through the different diaphragms. For this purpose, repeated measurements are carried out, and the observed object 4 to be examined is displaced in a direction B within the XY-plane vertical to the optical axis of the imaging device 3. The forward feed to be adjusted for the observed object 4 corresponds to the offset of the diaphragms 20 and 21 in the forward feed direction B.

A two-dimensional CCD matrix that is exposed after a stepwise displacement of the observed object 4 can be used as reception device 6. In the evaluating device 13, the measured intensities of the different recordings are evaluated with respect to identical locations on the observed object 4 and an actuating signal for the adjusting device 14 indicative of direction is generated from it.

However, image recording by means of a CCD matrix is often too slow for realizing an autofocus regulation with high bandwidth and with a dense arrangement of measurement points on the observed object 4.

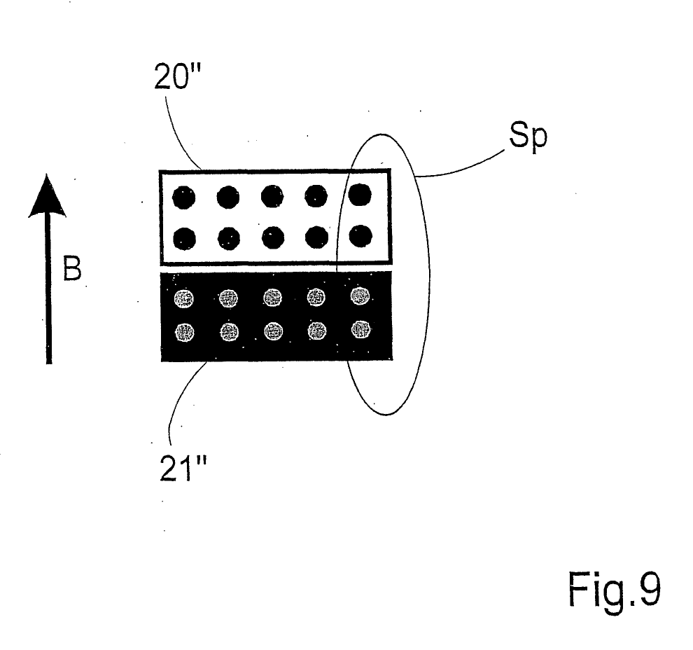

For faster image recording, a TDI line camera can be used as reception device 6. With a TDI line camera, the observed object 4 is recorded while moving, as is conventional when using this type of camera. The autofocusing method described above can be carried out in an analogous manner with the TDI line camera. For this purpose, the intensity is measured n times by the TDI line camera at every observation point. The detected signal is summed electronically in the camera. For this reason, structuring patterns must be repeated n times on each of the diaphragms. Compared to the use of a CCD matrix as reception device, the diaphragms are structured as in FIG. 8(b), where n=4.

In the following embodiment example which is described with reference to FIG. 9, two diaphragms are used. A first diaphragm 20″ is arranged in front of the field diaphragm 5 and a second diaphragm 21″ is arranged behind the field diaphragm 5. The n structuring patterns are formed as pinhole lines, wherein every gap Sp is associated with an individual observation point. Half of the n structuring patterns are distributed to diaphragm 20″ and half to diaphragm 21″.

As is indicated in FIG. 9 by the different light/dark distribution, a complementary aperture is structured on one of the diaphragms, where n=2 is selected in the example shown in FIG. 9. It is unimportant whether diaphragm 20″ is located in front of or behind diaphragm 21″ in the movement direction of the observed object 4 indicated by the arrow B.

Because of the complementary aperture, the receiver signal for a column Sp of the diaphragm structures, i.e., a column of the TDI line camera, results from the sum of n measurements with the pinhole diaphragm and n measurements with complementary pinhole diaphragm at the same point on the observed object.

This value is equal to the difference between a corresponding value of a pinhole diaphragm on diaphragm 20″ and an identical pinhole diaphragm on diaphragm 21″ up to a constant as will be shown by the following mathematical considerations.

For a fixed observation point or point on an observed object:

Iₚ_{_{—}}^{intra} is the intensity on the receiver through a pinhole diaphragm in the axial diaphragm plane 20″,

Iₚ_{_{—}}^{extra} is the intensity on the receiver through a pinhole diaphragm in the axial diaphragm plane 21″,

Iₙ_{_{—}}^{intra} is the intensity on the receiver through an inverted pinhole diaphragm in the axial diaphragm plane 20″,

Iₙ_{_{—}}^{extra} is the intensity on the receiver through an inverted pinhole diaphragm in the axial diaphragm plane 21″,

I₀ is the intensity on the reception device 6 without diaphragms in the beam path, and z is the axial position of the observed object 4.

Then, for every position of the observed object:

Iₚ_{_{—}}^{intra}(z)+Iₙ_{_{—}}^{intra}(z)=I₀(z)

and

Iₚ_{_{—}}^{extra}(z)+Iₙ_{_{—}}^{extra}(z)=I₀(z)

Therefore, the following is calculated from the sum:

Iₚ_{_{—}}^{intra}(z)+Iₙ_{_{—}}^{extra}(z)=Iₚ_{_{—}}^{intra}(z)+I₀(z)−Iₚ_{_{—}}^{extra}(z))=Iₚ_{_{—}}^{intra}(z)−Iₚ_{_{—}}^{extra}(z)+I₀(z)

Since I₀ changes only comparatively slightly with z (without diaphragm in the beam path, the illumination is identical to a brightfield illumination), the following can be assumed in a good approximation:

Iₚ_{_{—}}^{intra}(z)+Iₙ_{_{—}}^{extra}(z)=Iₚ_{_{—}}^{intra}(z)−Iₚ_{_{—}}^{extra}(z)+const.

By analogy,

Iₙ_{_{—}}^{intra}(z)+Iₚ_{_{—}}^{extra}(z)=Iₚ_{_{—}}^{extra}(z)−Iₚ_{_{—}}^{intra}(z)+const.

Accordingly, the method presented herein supplies a regulating input signal s as detector signal by which the direction of autofocusing can be controlled. Only measured values of the same point on the observed object go into the signal.

While the foregoing description and drawings represent the present invention, it will be obvious to those skilled in the art that various changes may be made therein without departing from the true spirit and scope of the present invention.

| | |
|---|---|
| 1 | microscope |
| 2 | illumination source |
| 3 | imaging device |
| 4 | observed object |
| 5 | field diaphragm |
| 6 | reception device |
| 7 | deflecting device |
| 8 | partially transparent layer |
| 9 | device |
| 10, 10′ | diaphragm |
| 11, 11′ | diaphragm |
| 12 | diaphragm |
| 13 | evaluating device |
| 14 | device/adjusting device |
| | adjusting device (B) |
| 20, 20′, 20″ | diaphragm |
| 21, 21′, 21″ | diaphragm |
| 21″ | axial diaphragm plane |
| 22 | individual pinhole diaphragms |
| 22′ | individual diaphragm aperture |
| 23 | individual pinhole diaphragms |
| 23′ | individual pinhole apertures |
| S | actuating signal/regulating input signal |
| L | illuminated field plane |
| E | plane |
| B | forward feed direction |
| Sp | column |
| K₁₀, K₁₁, K₁₂ | contrast value curves |

1. Microscope with autofocusing comprising an illumination source (2), an optical imaging device (3) by means of which light from the illumination source (2) is directed onto a point on an observed object (4), a reception device (6) which receives the light influenced by the observed object (4) in the form of an image field, and an adjusting device (14) for changing the distance between the imaging device (3) and the observed object (4), characterized in that a device (9) for structuring the light is arranged in the beam path between the illumination source (2) and the imaging device (3) or in a position optically conjugate thereto, the device (9) for structuring the illumination light has a plurality of diaphragms (10, 11, 12; 10′, 11′; 20, 21; 20′, 21′; 20″, 21″) which are arranged one behind the other in the direction of the beam path, wherein at least a first diaphragm (10; 10′; 20; 20′; 20″) and at least a second diaphragm (11; 11′; 21; 21′; 21″) are positioned in such a way with respect to a field diaphragm plane (L) that the field diaphragm plane (L) is focused on the reception device (6) at the same time as the observed object (4), and in that an evaluating device (13) cooperating with the reception device (6) is provided for the light intensities of the portion of the image field influenced by the diaphragms (10, 11, 12; 10′, 11′; 20, 21; 20′, 21′; 20″, 21″), wherein, depending on the determined light intensity, the evaluating device (13) generates an actuating signal (s) for actuating the adjusting device (14) and accordingly for focusing.

2. Microscope according to claim 1, characterized in that the diaphragms (10, 11, 12; 10′, 11′; 20, 21; 20′, 21′; 20″, 21″) are constructed and arranged in such a way that a high-contrast light structure is formed on the point at the observed object (4) to be imaged when one of the diaphragms (10, 11, 12; 10′, 11′; 20, 21; 20′, 21′; 20″, 21″) is optically conjugate to the point at the observed object (4) to be imaged.

3. Microscope according to claim 1 or 2, characterized in that the diaphragms (10, 11, 12; 10′, 11′; 20, 21; 20′, 21′; 20″, 21″) are offset relative to one another vertical to the beam path, so that a separate portion of the image field is allocated to every diaphragm (10, 11, 12; 10′, 11′; 20, 21; 20′, 21′; 20″, 21″).

4. Microscope according to claim 1 or 2, characterized in that the diaphragms (10′, 11′) overlap one another in the direction of the beam path, the diaphragms (10′, 11′) are formed so as to be partly transparent to light and have divergent optical structuring patterns.

5. Microscope according to one of claims 1 to 4, characterized in that the diaphragms (10, 11, 12; 10′, 11′; 20, 21; 20′, 21′; 20″, 21″) are provided with grating structures, and the grating lines of two diaphragms (10, 11, 12; 10′, 11′; 20, 21; 20′, 21′; 20″, 21″) intersect and/or are differently spaced relative to one another.

6. Microscope according to one of claims 1 to 5, characterized in that the evaluating device (13) is designed for generating a comparison value from the detected light intensity values or from contrast values derived from the latter with respect to a stored reference value, and the adjustment direction for the adjusting device (14) is derived from the comparison value.

7. Microscope according to claim 6, characterized in that the comparison value is generated by subtracting intensity values and/or contrast values and/or by dividing intensity values and/or contrast values.

8. Microscope according to one of claims 1 to 7, characterized in that a third diaphragm (12) is arranged between a first diaphragm (10) and a second diaphragm (11) in such a way that the imaging of the third diaphragm (12) is focused in the image field on the reception device (6) at the same time as the imaging of the observed object (4) in a reference position.

9. Microscope according to one of claims 1 to 8, characterized in that the first diaphragm (20; 20′; 20″) and the second diaphragm (21; 21′; 21″) have a large number of individual pinhole diaphragms (22, 23) which are arranged in such a way that their images on the reception device (6) are separate from one another, wherein a separate, light-sensitive area of the reception device (6) is allocated to every image.

10. Microscope according to one of claims 1 to 8, characterized in that the first diaphragm (20′) and the second diaphragm (21′) each have a plurality of stripe-shaped individual diaphragm apertures (22′, 23′) whose longitudinal extension directions intersect at a common point lying on the optical axis of the optical imaging device (3), and in that the stripe-shaped individual diaphragm apertures (22′, 23′) are arranged in such a way that their images on the reception device (6) are separate from one another, each image having a separate light-sensitive area of the reception device (6) associated with it.

11. Microscope according to claim 9 or 10, characterized in that the light intensity at the separate light-sensitive areas is selectively chosen.

12. Microscope according to one of claims 9 to 11, characterized in that devices are provided for moving the observed object (4) transverse to the optical axis of the imaging device (3), and structuring patterns formed at the diaphragms (10, 11, 12; 10′, 11′; 20, 21; 20′, 21′; 20″, 21″) are repeated in the movement direction (B), so that the light intensity of one and the same observed point can be measured repeatedly in the course of the movement of the observed object (4) through the structuring patterns.

13. Microscope according to claim 12, characterized in that the structuring patterns in the movement direction of the observed object (4) are arranged so as to be repeated n times, and the reception device (6) is constructed as a TDI camera for continuous measurement of the light intensities which sums the intensity values of n successive measurements at one and the same point on an observed object.

14. Microscope according to claim 12 or 13, characterized in that the structuring patterns are formed by n successive individual diaphragm apertures in the movement direction.

15. Microscope according to claim 14, characterized in that n is an even number and n/2 successive individual diaphragm apertures in the movement direction are formed as inverted patterns with respect to light transparency.
